(19) United States
(12) Patent Application Publication
(10) Pub. No.: US 2007/0188426 A1
(43) Pub. Date: Aug. 16, 2007

(54) LED driver circuit

(75) Inventors: Satoru Ito, Obu-shi (JP); Seijun Nishimura, Nogoya (JP)

Correspondence Address: YOKOI & CO. U.S.A., INC., 13700 MARINA POINTE DRIVE #723, MARINA DEL RAY, CA, 90292, US

(73) Assignee: AL-AID Corporation, Tokyo (JP)

(21) Appl. No.: 11/351,925

(22) Filed: Feb. 10, 2006

(51) Int. Cl. G09G 3/32

(52) U.S. Cl. 345/82

(57) ABSTRACT

Disclosed is an LED driver circuit that can suitably detect a minimum voltage and can be produced at low cost. A selector circuit is comprised of a comparator C, an inverter I and analogue switches. A minimum voltage selecting circuit can be constructed by causing the selector circuit and a circuit constructed in the same manner as the selector circuit is done, to be combined with each other. Therefore, the minimum voltage selecting circuit can be comprised of active devices that comprise only p-MOSFETs and n-MOSFETs. Moreover, as a semiconductor process structure, there may be employed a so-called single WELL structure in which a WELL is not formed in another WELL. The LED driver circuit is formed at low cost.

### BACKGROUND OF THE INVENTION

1. Field of the Invention

The present invention relates to an LED driver circuit.

2. Description of the Related Art

Hitherto, as LED driver circuit of this type, there is known an LED driver circuit that controls voltages to be applied to a plurality of LEDs, on the basis of a minimum voltage of cathode voltages of the LEDs (for example, U.S. Pat. No. 6,690,146).

FIG. 3 of the patent document illustrates a circuit in which cathode electrodes of a plurality of diodes are respectively connected to cathode electrodes of the LEDs and anode electrodes are all energized and connected to an input of an OPAMP. Reference voltages generated by a reference diode are inputted to the other input terminal of the OPAMP. The OPAMP generates output voltages corresponding to voltage differences of these input voltages. A charge pump circuit controls voltages to be applied to the respective LEDs, according to the output voltages of the OPAMP, whereby it is possible to realize the control of voltages according to variations in forward voltages (VF) of the LEDs.

In the above-mentioned LED driver circuit, the plurality of diodes are employed. In a case where a diode is realized on a substrate, there is a structural problem that a parasitic transistor will be formed. For example, as shown in FIG. 9, when a diode is produced by forming a P⁺ layer 2 and an N⁺ layer 3 on an n-WELL on a p-substrate, a parasitic bipolar transistor Q1 (PNP) is formed between the diode and a P⁺ layer 4 adjacent the diode. When a base current flows through the LED driver circuit, electric current flows between emitter collectors and then flows out through the P⁺ layer 4 to the ground from an anode.

As shown in FIG. 10, looking ahead to the fact that the parasitic transistor is formed in the diode, it is possible to prevent electric current from flowing out to the ground from the anode by designing in such a manner to not cause the parasitic transistor to be operated. In the structure shown in FIG. 10, by applying in advance voltage to an N⁺ layer 6 on an n-WELL 5 formed on a p-substrate, parasitic bipolar transistors Q2 (PNP) and Q3 (NPN) produced on a diode on a p-WELL 7 formed in the n-WELL can not be operated, so that electrical current can be prevented from flowing out through a P⁺ layer 8 to the ground from an anode.

However, the structure shown in FIG. 10 inevitably requires a double WELL structure in which the n-WELL 5 is formed on the p-substrate and a p-WELL 7 is formed in the n-WELL 5. In a case where the double WELL structure is formed, there are problems that, in the production process for the double WELL structure, the number of the steps including forming of resists, implanting of impurity ions, etc. is increased and the production cost is therefore increased.

Moreover, in the structure described in the above-mentioned patent, when the plurality of LEDs are minimized to the same degree, electric current is distributed to the plurality of diodes connected to the LEDs in which voltages are minimized, and flows through the diodes, so that forward voltages (VF) are minimized. In this case, inaccurate voltages are inputted to the OPAMP, resulting in raising-voltage voltages being unsuitably controlled.

### SUMMARY OF THE INVENTION

The present invention has been made with a view to overcoming the foregoing problems of the prior art LED driver circuits.

It is therefore an object of the present invention to provide an LED driver circuit that can suitably detect the minimum voltage and be made at low cost.

In order to attain the above object, in accordance with the present invention, there is provided an LED driver circuit formed on a semiconductor substrate. The LED driver circuit comprises a plurality of LEDs, a constant current circuit for supplying arbitrary current to the plurality of LEDs, a minimum voltage selecting circuit for detecting a minimum voltage from inputted cathode voltages of the plurality of LEDs, the minimum voltage selecting circuit comprising at least one selector circuit which is comprised of a comparator and an analogue switch, and a boost-converter circuit for supplying to the LEDs voltages based on the minimum voltage detected in the minimum voltage selecting circuit.

When the LED driver circuit is to be constructed as discussed above, the LED driver circuit is formed on the semiconductor substrate. The constant current circuit supplies the arbitrary current to the plurality of LEDs. The minimum voltage selecting circuit outputs the lowest voltage of a plurality of inputted estimation voltages to the exterior. The minimum voltage selecting circuit is provided with at least one selector circuit. The above selector circuit is comprised of the comparator and the analogue switch. The magnitude of the cathode voltages of the LEDs can be judged by the comparator. The analogue switch can carry out switching in such a manner to output a lower cathode voltage of the cathode voltage according to judging results obtained by the comparator.

Various comparison methods for comparing cathode voltages of three or more LEDs can be employed. Examples of the comparison methods to be carried out in a case where four LEDs are employed will be discussed hereinafter. Incidentally, cathode voltage signals of the four LEDs are respectively referred to as a signal A, a signal B, a signal C and a signal D in the following.

Comparison Method 1:

Three selector circuits which can output a lower voltage of two voltage signals by the comparator and the analogue switch are prepared.

In a first selector circuit, a lower voltage signal of the signals A, B is outputted.

In a second selector circuit, a lower voltage signal of the signals C, D is outputted.

In a third selector circuit, comparison is made between the output signal of the first selector circuit and the output signal of the second selector circuit, and a lower voltage signal of them is outputted.

In this way, the lower voltage signals are compared with each other, whereby the minimum voltage can be selected from the four cathode voltages and then outputted.

Comparison method 2:

Like the comparison method 1, three selector circuits which can output a lower voltage of two voltage signals by the comparator and the analogue switch are prepared.

In a first selector circuit, a lower voltage signal of the signals A, B is outputted.

In a second selector circuit, a lower voltage signal of the output signal of the first selector circuit and the signal C is outputted.

In a third selector circuit, a lower voltage signal of the output signal of the second selector circuit and the signal D is outputted.

In this way, it is possible to finally output the minimum voltage by causing the lower voltage signals to be synthetically compared with other voltage signals in order. Incidentally, in either of the comparison methods 1, 2, the number of the LEDs is not limited to four. That is, when the number of the LEDs in which cathode voltages are compared with each other is increased, the number of the selector circuits to be employed may be increased according to the number of the LEDs. Incidentally, the order of the signals A, B, C, D is in disorder in the above example.

In a preferred embodiment, the minimum voltage selecting circuit comprises active devices that comprise a p-MOSFET and an n-MOSFET.

In the structure described above, the active devices that are employed in the minimum voltage selecting circuit comprise the p-MOSFET and the n-MOSFET. The MOSFET facilitate the formation of a depletion layer between the devices and the substrate, and ensures insulation between adjacent devices, so that it is unnecessary to take the effect of a parasitic transistor into consideration. Concretely, the above-mentioned p-MOSFET and n-MOSFET can be realized by a so-called single WELL structure in which a WELL is not formed in another WELL. Therefore, the parasitic transistor is not a problem, and the minimum voltage selecting circuit that is simple in structure can be formed at low cost.

In another preferred embodiment, the comparator is designed so as to output results of comparison between a pair of the cathode voltages as switching signals of the analogue switch. When the LED driver circuit is constructed as described above, it is possible to cause the analogue switch to be operated according to the magnitude of the pair of cathode voltages, and possible to cause a lower cathode voltage of the cathode voltages to be outputted from the analogue switch.

In still another preferred embodiment, the analogue switch is comprised of at least one pair of MOSFETs that are inverted due to receive the switching signals through their gates, the cathode voltages being adapted to be inputted to their sources. When the LED driver circuit is constructed as described above, it is possible to cause the pair of MOSFETs which receive the cathode voltages through the sources, to be inverted each other by the switching signals according to the comparison between the magnitudes of the pair of cathode voltages. That is, when one of the above MOSFET becomes ON, the other of the MOSFET becomes OFF. The cathode voltages are inputted to the sources of the MOSFETs, so that the inversion of the MOSFETs allows a lower voltage of the cathode voltages to be outputted from respective drains of the MOSFETs.

In yet another preferred embodiment, the one pair of MOSFETs are the same channels and the switching signal is adapted to be inputted to a gate of one of the MOSFETs through an inverter. In this way, the input of the switching signal to the gate of the one of the MOSFETs is inverted, so that even if the MOSFETs are the same channels, they can realize the inverting operation.

### BRIEF DESCRIPTION OF THE DRAWINGS

The above and other objects and many of the attendant advantages of the present invention will be readily appreciated as the same becomes better understood by reference to the following detailed description when considered in conjunction with the accompanying drawings, in which like reference numerals designate the same parts through the Figures and wherein;

FIG. 1 a schematic block diagram of an LED driver circuit;

FIG. 2 is a schematic circuit diagram of a minimum voltage selecting circuit;

FIG. 3 is a schematic circuit diagram of a selector circuit;

FIG. 4 is a schematic circuit diagram of a comparator;

FIG. 5 is a schematic circuit diagram of an inverter;

FIG. 6 is a schematic view of a structure for the minimum voltage selecting circuit;

FIG. 7 is a schematic circuit diagram of a selector circuit for a variant;

FIG. 8 is a schematic circuit diagram of a minimum voltage selecting circuit for a variant;

FIG. 9 is a schematic view of a structure for a conventional minimum voltage selecting circuit; and

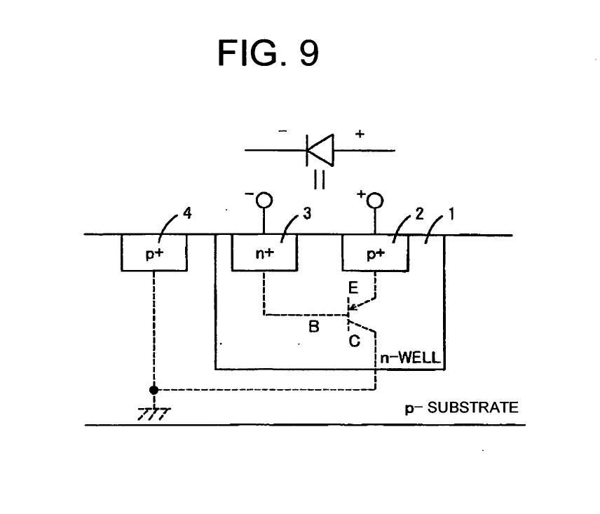

FIG. 10 is a schematic view of a structure for another conventional minimum voltage selecting circuit.

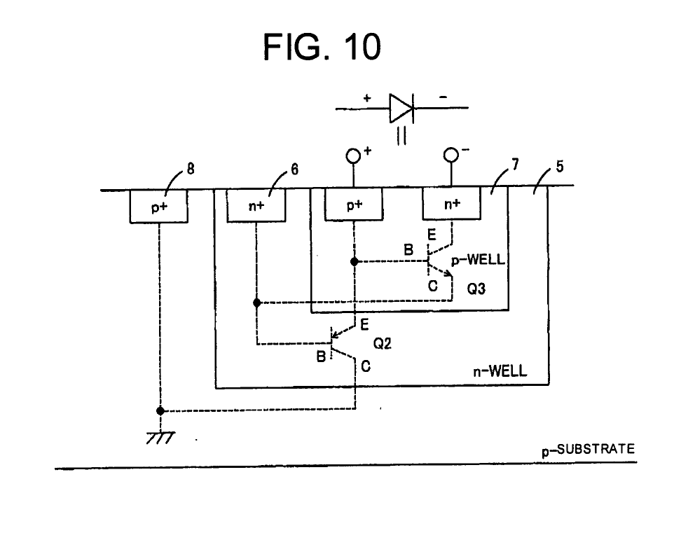

### DESCRIPTION OF THE PREFERRED EMBODIMENTS

Preferred embodiments according to the present invention will be discussed hereinafter in the following order.

(1) Structure of an LED driver circuit;

(2) Structure of a minimum voltage selecting circuit;

(3) Variants; and

(4) Summary.

(1) Structure of an LED driver circuit:

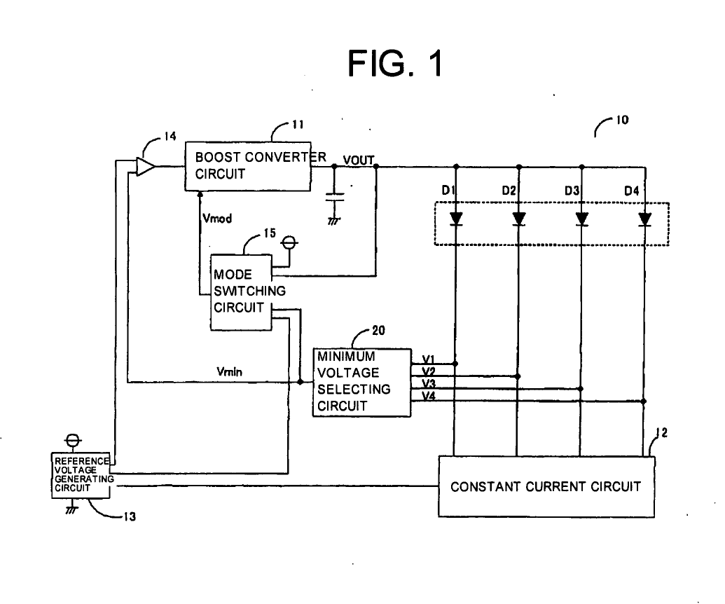

FIG. 1 is a schematic diagram illustrating an LED (Light Emitting Diode) driver circuit. In the LED driver circuit shown in the same Figure, a boost-converter circuit 11 is adapted to supply voltages to anodes of LEDs D1-D4 arranged in parallel. A constant current circuit 12 is a pump-type circuit and adapted to carry out control in such a manner to allow arbitrary current to flow through the respective LEDs D1-D4.

Cathode voltages V1-V4 of the LEDs Dl-D4 are adapted to be inputted to a minimum voltage selecting circuit 22 as estimation voltages V1-V4. The minimum voltage selecting circuit 22 is adapted to detect a minimum voltage Vₘᵢₙ from the estimation voltages V1-V4 and output the minimum voltage Vₘᵢₙ to an OPAMP 14 at a following section. The OPAMP 14 is adapted to always receive a constant reference voltage V_{ref} from a reference voltage generating circuit 13, determine an output voltage according to a voltage difference between the minimum voltage Vₘᵢₙ and the reference voltage V_{ref}, and output the output voltage to the boost-converter circuit 11.

A mode switching circuit 15 is adapted to obtain information from a supply voltage, a raising-voltage voltage, the minimum voltage Vₘᵢₙ and the reference voltage V_{ref}, and send a switch signal V_{mod} to the boost-converter circuit 11 in such a manner that the boost-converter circuit 11 can be operated in suitable mode. The boost-converter circuit 11 receives the switch signal V_{mod} from the mode switching circuit 15 and is then operated in the suitable mode according to the switch signal V_{mod}. The boost-converter circuit 11 is so operated, whereby voltages required to supply electric current to the LEDs D1-D4 can be outputted. Now, the mode operation which is carried out by the boost-converter circuit 11 will be discussed hereinafter.

For example, in a case where the minimum voltage Vₘᵢₙ is sufficiently high and is not required to be pressed up, the mode switching circuit 15 outputs to the boost-converter circuit 11 a switch signal V_{mod} for causing the boost-converter circuit 11 to be operated in a single mode. The boost-converter circuit 11 which receives the switch signal V_{mod} is then operated in the single mode and supplies to the respective LEDs D1-D4 voltages approximately equal to the supply voltage. On the other hand, in a case where the minimum voltage Vₘᵢₙ is lowered and required to be pressed up, the mode switching circuit 15 outputs to the boost-converter circuit 11 a switch signal V_{mod} for causing the boost-converter circuit 11 to be operated in a half time or a double mode. According to this, the boost-converter circuit 11 which receives the switch signal V_{mod} is operated in the half time or the double mode, presses up the supply voltage according to the magnification, and then supplies voltages to the respective LEDs D1-D4. The above-mentioned feedback control is successively performed, whereby the minimum voltage Vₘᵢₙ can be finally converged to the reference voltage V_{ref}.

(2) Structure of the minimum voltage selecting circuit:

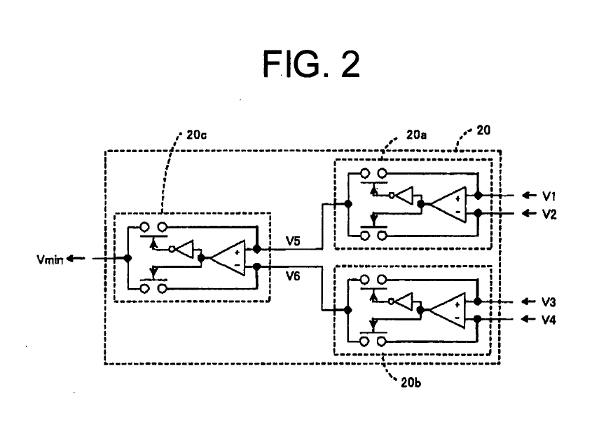

FIG. 2 illustrates a circuit structure for the minimum voltage selecting circuit 20. As shown in FIG. 2, the minimum voltage selecting circuit 20 is comprised of three selector circuits 20a, 20b, 20c constructed in the same manner. The selector circuit 20a receives estimation voltages V1, V2 and outputs a lower voltage of the estimation voltages as an estimation signal V5 for the selector circuit 20c at a following section. Similarly, the selector circuit 20b receives estimation voltages V3, V4 and outputs a lower voltage of the estimation voltages as an estimation signal V6 for the selecting circuit 20c at the following section. The selector circuit 20c receives the estimation voltages V5, V6 and outputs a lower voltage of the estimation voltages as the minimum voltage Vₘᵢₙ. That is, the minimum voltage selecting circuit can output the lowest voltage of the estimation voltages V1-V4 as the minimum voltage Vₘᵢₙ.

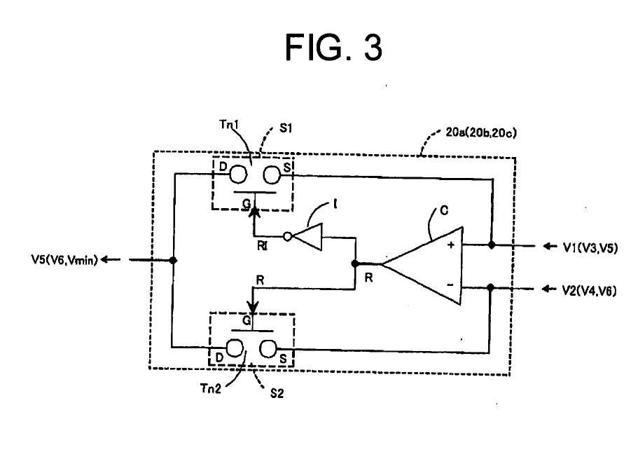

FIG. 3 fully illustrates the structure of the selector circuit 20a. Incidentally, the circuit structures of the other selector circuits 20b, 20c are similar to the structure of the selector circuit 20a. Therefore, only the selector circuit 20a is representatively illustrated. The selector circuit 20a is comprised of a comparator C, an inverter I and analogue switches S1, S2. The estimation voltage V1 is inputted to an input terminal on the side of the plus of the comparator C. The estimation voltage V2 is inputted to an input terminal on the side of the minus of the comparator C. The comparator C makes a comparison of the magnitude between the estimation voltages V1, V2. In a case where the estimation voltage V1 is higher than the estimation voltage V2, the comparator C outputs a high level switching signal R from an output terminal thereof as a comparison result. Conversely, when the estimation voltage V2 is higher than the estimation voltage V1, the comparator C outputs a low level switching signal R from the output terminal thereof as a comparison result.

The inverter I is a circuit that inverts the switching signal and outputs it. The inverter I is adapted to receive the switching signal R inputted from the output terminal of the comparator C, inverts the switching signal R and then outputs the inverted switching signal R_{I}. Incidentally, the switching signal R that has been inverted by the inverter I shall be hereinafter referred to as an “inverted switching signal R_{I}”. The analogue switch S1 is comprised of an n-MOSFET Tₙ1. The output terminal of the comparator C is connected through the inverter I to a gate G of the n-MOSFET Tₙ2. The estimation voltage V1 is inputted to a source S of the n-MOSFET Tₙ1. The input terminal of the selector circuit 20c at the following section is connected to a drain D. On the other hand, the analogue switch S2 is comprised of an n-MOSFET Tₙ2 that is an n-channel like the n-MOSFET Tₙ1. The output terminal of the comparator C is connected to a gate G of the n-MOSFET Tₙ2. The estimation voltage V2 is inputted to a source of the n-MOSFET Tₙ2. The input terminal of the selector circuit 20c at the following section is connected to a drain D.

The analogue switches S1, S2 are both comprised of the n-MOSFETs, so that when high level voltage signals are inputted to the gates G, they become ON-conditions and an electric current is applied between the sources S and the drains D. Conversely, when low level voltage signals are inputted to the gates G, the analogue switches S1, S2 become OFF-conditions and the energizing between the sources S and the drains D is cut off.

The operation of the selector circuit 20a constructed as discussed above which is carried out in a case where the estimation voltage V1 is higher than the estimation voltage V2 will be discussed hereinafter. In the case where the estimation voltage V1 is higher than the estimation voltage V2, the comparator C outputs the high level switching signal R and the inverter I outputs the inverted low level switching signal R_{I}. At this time, the inverted low level switching signal R_{I} is inputted to the gate G of the n-MOSFET Tₙ1 constituting the analogue switch S1 and the high level switching signal R is inputted to the gate G of the n-MOSFET Tₙ2 constituting the analogue switch S2, so that the analogue switch S1 becomes OFF, whereas the analogue switch S2 becomes ON. Therefore, the estimation voltage V1 is interrupted by the analogue switch S1 and the estimation voltage V2 is outputted to the exterior through the source S and drain D of the n-MOSFET Tₙ2 constituting the analogue switch S2. That is, it is possible output the lower estimation voltage V2 to the exterior.

Next, the operation of the selector circuit 20a that is carried out in a case where the estimation voltage V2 is higher than the estimation voltage V1 will be discussed hereinafter. In the case where the estimation voltage V2 is higher than the estimation voltage V1, the comparator C outputs the low level switching signal R and the inverter I outputs the inverted high level switching signal R_{I}. At this time, the inverted high level switching signal R_{I} is inputted to the gate G of the n-MOSFET Tₙ1 constituting the analogue switch S1, and the low level switching signal is inputted to the gate G of the n-MOSFET Tₙ2 constituting the analogue switch S2, so that the analogue switch S1 becomes ON, whereas the analogue switch S2 becomes OFF. Therefore, the estimation voltage V1 is outputted to the exterior through the source S and drain D of the n-MOSFET Tₙ1 constituting the analogue switch S1, whereas the estimation voltage v2 is interrupted by the analogue switch S2. That is, in the case where the estimation voltage V2 is higher than the estimation voltage V1, it is possible to also output the lower estimation voltage V1 to the exterior.

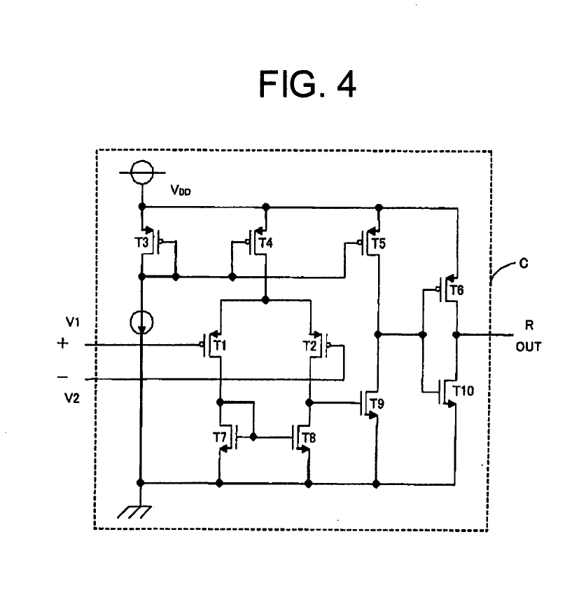

FIG. 4 illustrates one example of the circuit structure for the comparator C. As shown in FIG. 4, the comparator C is comprised of six p-MOSFETs T1-T6 and four n-MOSFETs T7-T10 which act as semiconductor active devices. The comparator C receives the estimation voltage V1 through a plus input terminal thereof and receives the estimation voltage V2 through a minus input terminal thereof. The estimation voltages V1, V2 are applied to gates G of the p-MOSFETs T1, T2 opposite to each other. Comparison is made between the magnitude of the estimation voltage V1 and the magnitude of the estimation voltage V2. In a case where the estimation voltage V1 that is inputted to the plus input terminal is higher than the estimation voltage V2, the p-MOSFET T6 becomes ON and the n-MOSFET T10 becomes OFF, so that a plus supply voltage V_{DD} can be outputted as the switching signal R. On the other hand, in a case where the estimation voltage V2 that is inputted to the minus input terminal is higher than the estimation voltage V1, the p-MOSFET T6 becomes OFF and the n-MOSFET T10 becomes ON, whereby the voltage level of the output terminal can be drawn to the ground. Incidentally, while the above-mentioned structure for the comparator C is the one example, another structure for the comparator C may be employed.

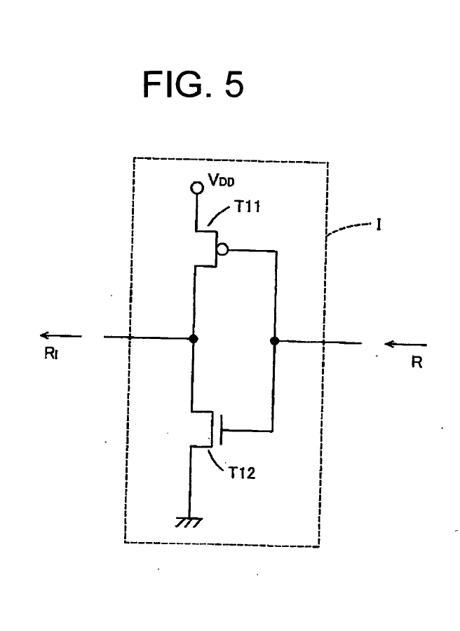

FIG. 5 illustrates one example of a circuit structure for the inverter I. As shown in FIG. 5, the inverter I is a so-called CMOS inverter circuit that is comprised of a pair of a p-MOSFET T11 and an n-MOSFET T12. In a case where the high level switching signal R is inputted, the n-MOSFET T12 becomes ON, whereby the inverted switching signal R_{I} is drawn to the ground and brought to a low level. On the other hand, in a case where the low level switching signal R is inputted, the p-MOSFET T11 becomes ON and the n-MOSFET T12 becomes OFF, whereby the positive supply voltage V_{DD} can be outputted as the inverted high level switching signal R_{I}. Incidentally, while the above-mentioned circuit structure for the inverter I is the one example, of course, another circuit structure for the inverter I may be employed.

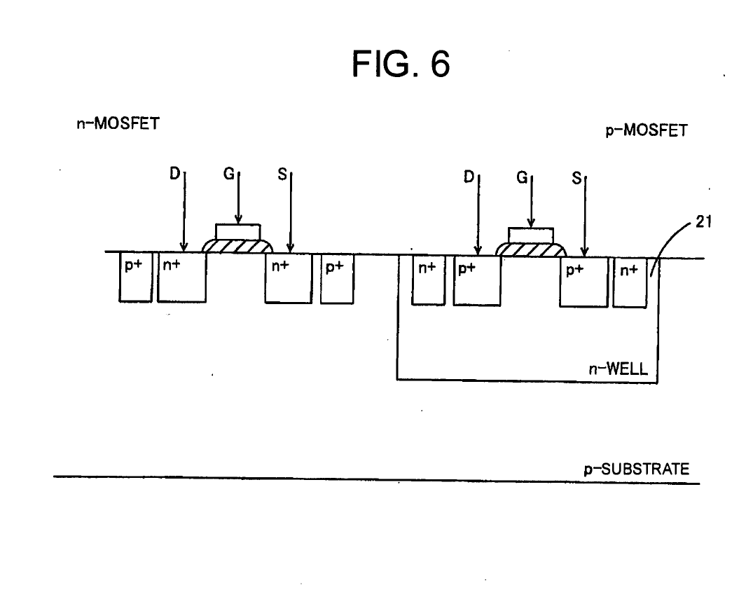

The minimum voltage selecting circuit 20 that is comprised of the plurality of the selector circuit 20a, 20b, 20c as discussed above comprises only the p-MOSFETs and the p-MOSFETs as the semiconductor active devices. According to the MOSFETs, a depletion layer can be formed around a periphery by the voltages applied to the gates G, so that it is unnecessary to provide insulation between the devices and take a parasitic device in account. Therefore, a p-MOSFET Tₚ1 and an n-MOSFET Tₙ1 which constitute the selector circuit 20a can be constructed, for example, in such a manner as to be illustrated in FIG. 6. As shown in FIG. 6, the p-MOSFET Tₚ1 is formed on a p-type semiconductor substrate (p-substrate) and the n-MOSFET Tₙ1 is formed on an n-WELL 21 which is formed on the p-substrate. In this way, only the p-MOSFET and the n-MOSFET are employed as the semiconductor active devices of the minimum voltage selecting circuit 20, so that the selector circuits 20a, 20b, 20c can be formed into single WELL structures and the LED driver circuit 10 can be provided at low cost.

(3) Variants:

As discussed above, the selector circuit 20a can output the lower estimation voltage of the estimation voltages V1, V2. Incidentally, the analogue switches S1, S2 may be able to carry out the switching using the MOSFETs and the p-MOSFETs may be employed by changing logic of the switching signal. Moreover, the analogue switches may be realized as transmission-type switches in which p-MOSFETs and n-MOSFETs are paired up.

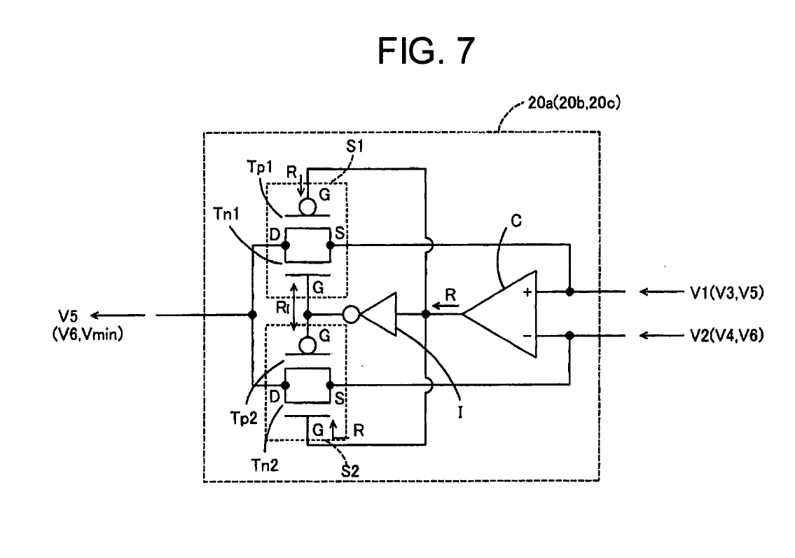

FIG. 7 illustrates a circuit structure for the selector circuit 20a, which is comprised of transmission-type analogue switches S1, S2. The analogue switch S1 is comprised of a p-MOSFET Tₚ1 and an n-MOSFET Tₙ1. Source S of the p-MOSFET Tₚ1 and n-MOSFET Tₙ1 are connected to each other. Their drains D are connected to each other. On the other hand, the analogue switch S2 is comprised of a p-MOSFET Tₚ2 and an n-MOSFET Tₙ2. Their sources S are connected to each other. Their drains D are connected to each other.

The estimation voltage V1 is inputted to the source S of the p-MOSFET Tₚ1 and the source S of the n-MOSFET Tₙ1. The estimation voltage V2 is inputted to the source S of the p-MOSFET Tₚ2 and the source of the n-MOSFET Tₙ2. The drains D of the p-MOSFETs Tₚ1, Tₚ2 and the drains D of the n-MOSFETs Tₙ1, Tₙ2 are connected to the exterior. Voltage can be outputted from the drains D to the exterior of the selector circuit 20a. The switching signal R that is outputted from the comparator C is inputted to the inverter I in which the voltage level of the switching signal R is inverted.

The switching signal R that is outputted from the comparator C is inputted to the gate G of the p-MOSFET Tₚ1 receiving the estimation voltage V1 through the source S thereof, and the gate G of the n-MOSFET Tₙ2 receiving the estimation voltage V2 through the source S thereof. On the other hand, the inverted switching signal R_{I} that is outputted from the inverter I is inputted to the gate G of the n-MOSFET Tₙ1 receiving the estimation voltage V1 through the source S thereof, and the gate G of the p-MOSFET Tₚ2 receiving the estimation voltage V2 through the source S thereof.

The operation of the selector circuit 20a constructed as discussed above that is performed in a case where the estimation voltage V1 is higher than the estimation voltage V2 will be discussed hereinafter. In the case where the estimation voltage V1 is higher than the estimation voltage V2, the high level switching signal R is outputted from the comparator C and the inverted low level switching signal R_{I} is outputted from the inverter I. The high level switching signal R is inputted to the gate G of the p-MOSFET Tₚ1, so that the p-MOSFET Tₚ1 becomes OFF. The inverted low level switching signal R_{I} is inputted to the gate G of the n-MOSFET Tₙ1, so that the n-MOSFET Tₙ1 also becomes OFF. That is, the p-MOSFET Tₚ1 and the n-MOSFET Tₙ1 in which their sources S are connected to each other and their drains D are connected to each other become OFF, and the analogue switch S1 becomes OFF as a whole. Therefore, the estimation voltages V1 that are inputted to the source of the p-MOSFET Tₚ1 and the source of the n-MOSFET Tₙ1 are interrupted.

On the other hand, the inverted low level switching signal R is inputted to the gate G of the p-MOSFET Tₚ2, so that the p-MOSFET Tₚ2 becomes ON. Also, the high level switching signal R is inputted to the gate G of the n-MOSFET Tₙ2, so that the n-MOSFET Tₙ2 also becomes ON. That is, the p-MOSFET Tₚ2 and the n-MOSFET Tₙ2 in which their sources S are connected to each other and their drains D are connected to each other become ON and the analogue switch S2 becomes ON as a whole. Therefore, the estimation voltages V2 that are inputted to the source S of the p-MOSFET Tₚ2 and the source S of the n-MOSFET Tₙ2 are outputted from the drains D to the exterior. As discussed above, when the estimation voltage V1 is higher than the estimation voltage V2, the lower estimation voltage can be outputted to the exterior.

Next, the operation of the selector circuit 20a that is performed in a case where the estimation voltage V2 is higher than the estimation voltage V1 will be discussed hereinafter. In the case where the estimation voltage V2 is higher than the estimation voltage V1, the low level switching signal R is outputted from the comparator C and the inverted high level switching signal R_{I} is outputted from the inverter I. The low level switching signal R is inputted to the gate G of the p-MOSFET Tₚ1, so that the p-MOSFET Tₚ1 becomes ON. Also, the inverted high level switching signal R₁ is inputted to the gate G of the n-MOSFET Tₙ1, so that the n-MOSFET Tₙ1 also becomes ON and the analogue switch S1 becomes ON as a whole. That is, the p-MOSFET Tₚ1 and the n-MOSFET Tₙ1 in which their sources S are connected to each other and their drains D are connected to each other become ON, so that the estimation voltages V1 inputted to the sources S are outputted to the exterior from the drains D.

On the other hand, the inverted high level switching signal R_{I} is inputted to the gate G of the p-MOSFET Tₚ2, so that the p-MOSFET Tₚ2 becomes OFF. Also, the low level switching signal R is inputted to the gate G of the n-MOSFET Tₙ2, so that the n-MOSFET Tₙ2 also becomes OFF and the analogue switch S2 becomes OFF as a whole. That is, the both of the p-MOSFET Tₚ2 and the n-MOSFET Tₙ2 in which their sources S are connected to each other and their drains D are connected to each other become OFF, so that the estimation voltages V2 inputted to the sources S are interrupted. As discussed above, when the estimation voltage V2 is higher than the estimation voltage V1, the lower estimation voltage V1 can be outputted to the exterior.

While the minimum voltage selecting circuit 20 in which the minimum voltage Vₘᵢₙ is selected from the cathode voltages of the four LEDs in the above mentioned embodiments is discussed above, it is possible to select the minimum voltage from an increased number of the cathode voltages by increasing connection sections in the selector circuit 20a. Moreover, while the comparison method in which lower voltage signals are in order compared with each other is discussed above, another comparison method may be employed.

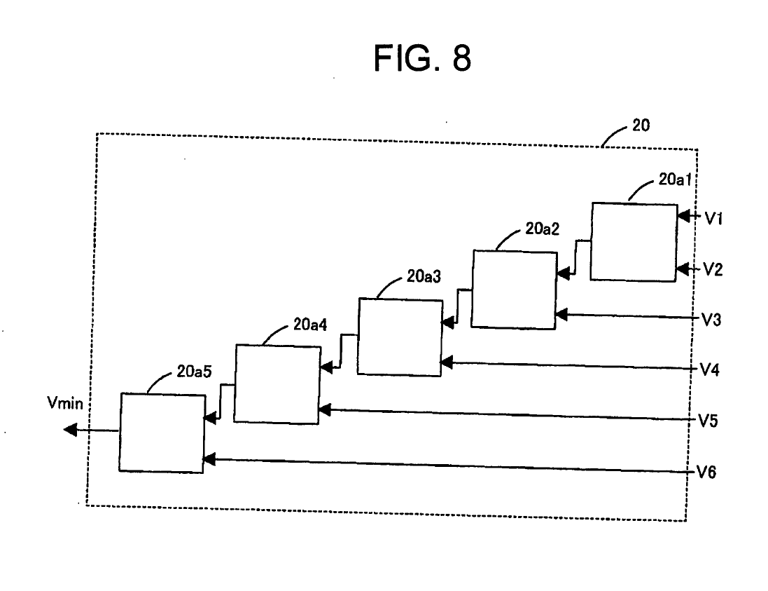

FIG. 8 illustrates an alternate of the circuit structure of the minimum voltage detecting circuit 20. In the circuit structure shown in FIG. 8, six system-estimation voltages V1-V6 are inputted to the minimum voltage detecting circuit 20 from the cathodes of unshown LEDs. In this alternate, it is possible to select the minimum voltage Vₘᵢₙ from the cathode voltages of the six LEDs. The estimation voltages V1, V2 are inputted to a selector circuit 20a1 at a first section, from which the lower estimation voltage V1 or V2 is outputted to a selector circuit 20a2 at a second section. The selector circuit 20a2 receives an estimation voltage V3 through one input terminal thereof and is operated so as to output the lowest voltage of the estimation voltages V1, V2, V3 to a selector circuit 20a2 at a third section.

The above-mentioned operation is carried out in the same manner in a selector circuit 20a5 at a final sixth section. It is possible to finally output the lowest voltage of the estimation voltages V1-V6 to the exterior, as the minimum voltage Vₘᵢₙ. When the circuit structure for the minimum voltage detecting circuit 20 is constructed in the same manner as the structure of FIG. 8 is done, if the number of the LEDs is not the multiplier of 2, a combination of the selector circuits facilitates detecting of the minimum voltage. Of course, the circuit structure of FIG. 8 and the circuit structure of FIG. 2 may be combined with each other.

(4) Summary:

According to the present invention, the selector circuit 20a is comprised of the comparator C, the inverter I and the analogue switches S1, S2. The minimum voltage selecting circuit 20 can be constructed by causing the selector circuit 20a and another circuit that is constructed in the same manner as the selector circuit 20a is done, to be combined with each other. Therefore, the minimum voltage selecting circuit 20 can be constructed by the active devices which comprise only the p-MOSFET and the n-MOSFET. Moreover, as a structure of the semiconductor, there may be employed a so-called single WELL structure in which a WELL is not formed in another WELL. Therefore, it can be produced at low cost.

While the invention has been particularly shown and described with respect to preferred embodiments thereof, it should be understood by those skilled in the art that the foregoing and other changes in form and detail may be made therein without departing from the spirit and scope of the invention as defined in the appended claims.

We claim:

1. An LED driver circuit formed on a semiconductor substrate, said LED driver circuit comprising:
a plurality of LEDs;
a constant current circuit for supplying arbitrary current to the plurality of LEDs;
a minimum voltage selecting circuit for detecting a minimum voltage from inputted cathode voltages of the plurality of LEDs;
said minimum voltage selecting circuit comprising at least one selector circuit which is comprised of a comparator and an analogue switch; and
a boost-converter circuit for supplying to said LEDs voltages based on said minimum voltage detected in said minimum voltage selecting circuit.

2. An LED driver circuit according to claim 1, wherein said minimum voltage selecting circuit employs active devices which comprise a p-MOSFET and an n-MOSFET.

3. An LED driver circuit according to claim 1, wherein said comparator is designed so as to output results of comparison between a pair of said cathode voltages as switching signal for said analogue switch.

4. An LED driver circuit according to claim 3, wherein said analogue switch is comprised of at least one pair of MOSFETs that are inverted due to receive the switching signals through their gates, the cathode voltages being adapted to be inputted to their sources.

5. An LED driver circuit according to claim 4, wherein said one pair of MOSFETs are the same channels and said switching signal is adapted to be inputted to a gate of one of said pair of MOSFETs through an inverter.
